(19) United States
(12) Patent Application Publication
(10) Pub. No.: US 2011/0104476 A1
(43) Pub. Date: May 5, 2011

(54) Soft magnetic material, motor core, transformer core, and method for manufacturing soft magnetic material

(76) Inventors: Haruhisa Toyoda, Hyogo (JP); Daichi Kawaguchi, Hyogo (JP); Shohzoh Tanaka, Osaka (JP); Kazuhiko Ueda, Osaka (JP)

(21) Appl. No.: 10/552,417

(22) PCT Filed: May 28, 2004
(86) PCT No.: PCT/JP04/07798

§ 371 Date: Oct. 6, 2005

(30) Foreign Application Priority Data
May 30, 2003 (JP) 2003-155083

(51) Int. Cl. B32B 15/02; B32B 33/00; B22F 1/00; B22F 3/12

(52) U.S. Cl. 428/328; 428/407; 419/37

(57) ABSTRACT

A soft magnetic material includes a composite magnetic particle and an organic substance. The composite magnetic particle has a metallic magnetic particle and a coating layer coating the metallic magnetic particle and containing an oxide therein. The organic substance is formed by adding at least one of a thermoplastic resin and a higher fatty acid having an effect of increasing resistivity of the material, to a non-thermoplastic resin having an effect of improving durability such as material fatigue limit. The organic substance is contained in the soft magnetic material by not less than 0.001% by mass and not more than 0.2% by mass. The present invention provides a soft magnetic material having high magnetic property and mechanical strength and also having fatigue property and resistivity satisfying durability enough for use as a motor core or the like, and a method for manufacturing the same. Further, the invention provides a motor core and a transformer core made of the soft magnetic material. A core loss can significantly be reduced in a motor core made of the soft magnetic material.

### TECHNICAL FIELD

The invention relates to a soft magnetic material for use in particular in a motor core or the like having excellent fatigue and magnetic properties, a method for manufacturing the same, and a motor core and a transformer core.

### BACKGROUND ART

In recent years, higher-density, more miniaturized electric and electronic components have been developed, and components such as motor cores and transformer cores are required to provide more accurate control with low electric power. Thus, soft magnetic materials for use in these electric and electronic components having high magnetic property in the range of middle to high frequencies are under development. To obtain high magnetic property in the range of middle to high frequencies, high saturation magnetic flux density, magnetic permeability, and electrical resistivity should be achieved simultaneously.

Motor cores and the like are also required to have mechanical strength necessary when electric and electronic equipment is processed and assembled, and used as a product. Japanese Patent Laying-Open No. 2002-246219 discloses a soft magnetic material having a resin content of 0.15% by mass to 1% by mass to achieve high magnetic property and mechanical strength simultaneously. In the soft magnetic material, the resin content is set at not less than 0.15% by mass, because magnetic powder particles have less bond strength and insulation effect if the resin content is less than 0.15% by weight.

Unlike a metallic material, however, a resin does not have a strict fatigue limit. Thus, if a soft magnetic material contains more resin, the soft magnetic material cannot obtain high fatigue property. Therefore, it cannot be said that the soft magnetic material having a resin content of 0.15% by mass to 1% by mass is durable enough to be used as a motor core for a long period of time.

### DISCLOSURE OF THE INVENTION

One object of the invention is to solve the problem described above, and to provide a soft magnetic material having high magnetic property and mechanical strength and also having fatigue property and resistivity satisfying durability enough for use as a motor core or the like, and a method for manufacturing the same. A further object of the invention is to provide a motor core and a transformer core made of the soft magnetic material.

A soft magnetic material according to the present invention is a soft magnetic material including a composite magnetic particle and an organic substance. The composite magnetic particle has a metallic magnetic particle and a coating layer coating the metallic magnetic particle and containing an oxide therein. The organic substance is formed by adding at least one of a thermoplastic resin and a higher fatty acid to a non-thermoplastic resin. The non-thermoplastic resin has an effect of improving durability such as material fatigue limit, and the thermoplastic resin and the higher fatty acid have an effect of increasing resistivity of the material. The organic substance is contained in the soft magnetic material by not less than 0.001% by mass and not more than 0.2% by mass.

A non-thermoplastic resin is a resin which has a property similar to that of a thermoplastic resin and whose melting point does not exist at a temperature of not more than a thermal decomposition temperature.

Using a non-thermoplastic resin in the organic substance can suppress deterioration of mechanical strength and improve durability such as material fatigue limit, when compared to the case using a thermoplastic resin only. By setting the content of the organic substance including the non-thermoplastic resin at not more than 0.2% by mass, a soft magnetic material having a sufficient mechanical strength even in a 10⁸ times repeated transverse test can be obtained. Thereby, high fatigue property and magnetic flux density can be achieved. Further, when the content of the organic substance including the non-thermoplastic resin is less than 0.001% by mass, it is impossible to sufficiently increase the mechanical strength and the resistivity of the material. Therefore, by setting the content of the organic substance including the non-thermoplastic resin at not less than 0.001% by mass and not more than 0.2% by mass, a soft magnetic material having high fatigue property as well as high resistivity and magnetic flux density can be obtained.

On the other hand, adding at least one of the thermoplastic resin and the higher fatty acid to the non-thermoplastic resin can suppress destruction of the coating layer of the composite magnetic particle during the step of compression molding. Further, the thermoplastic resin or the higher fatty acid enters into the coating layer destroyed in the step of stabilizing heat treatment, producing an effect of repairing the destroyed coating layer. With these actions, the resistivity of the material can be increased, significantly reducing a core loss when using the material as an iron core.

Furthermore, the thermoplastic resin is preferably one of a fluorine-type resin, a thermoplastic polyimide, a thermoplastic polyamide, a thermoplastic polyamideimide, and a high-molecular-weight polyethylene. A thermoplastic polyimide, a thermoplastic polyamide, and a thermoplastic polyamideimide are excellent in both of mechanical strength and resistivity. A high-molecular-weight polyethylene is a polyethylene having a molecular weight of not less than 100,000. Furthermore, the higher fatty acid is preferably zinc stearate. Zinc stearate can increase the resistivity of the soft magnetic material even if only a small amount is added. Since the amount of zinc stearate to be added is small, the density of the composite magnetic particle can be increased to increase magnetic flux density. For the reasons described above, high insulation and magnetic flux density can be achieved in the soft magnetic material having high fatigue property by adding these organic materials to the non-thermoplastic resin.

Using a material composition and a molding and sintering technique in accordance with the present invention, with the thermoplastic resin or the higher fatty acid added, makes it possible to obtain a material having a property which cannot been achieved conventionally, that is, a soft magnetic material having a magnetic flux density B of not less than 1.4 (tesla) and a resistivity of not less than 1000 (μΩcm) when a magnetic field of 8.0×10³ (A/m) is applied.

Furthermore, the non-thermoplastic resin is preferably a wholly aromatic polyimide using biphenyl tetracarboxylic dianhydride. Since biphenyl tetracarboxylic dianhydride has a high transverse rupture strength when used alone as a resin, it can suppress crack of a resin melting into a grain boundary between the metallic magnetic particles to reduce the strength of the soft magnetic material.

A motor core according to the present invention is a motor core using an iron core made of the soft magnetic material in one of the above descriptions. Furthermore, a transformer core according to the present invention is a transformer core using an iron core made of the soft magnetic material in one of the above descriptions. The above effect can be obtained in the motor core and the transformer core by using an iron core made of the soft magnetic material according to the present invention in this manner.

A method of manufacturing a soft magnetic material according to the present invention is a method of manufacturing a soft magnetic material including a composite magnetic particle and an organic substance, the composite magnetic particle having a metallic magnetic particle and a coating layer coating the metallic magnetic particle and containing an oxide therein. The method of manufacturing a soft magnetic material includes the steps of: mixing the organic substance and the composite magnetic particle such that the organic substance formed by adding at least one of a thermoplastic resin and a higher fatty acid to a non-thermoplastic resin is contained in the soft magnetic material by not less than 0.001% by mass and not more than 0.2% by mass; compression molding mixed powder obtained by the step of mixing; and, after the step of compression molding the mixed powder, subjecting the soft magnetic material to stabilizing heat treatment at a temperature of not less than 200° C. and not more than a thermal decomposition temperature of the non-thermoplastic resin. Thereby, the organic substance serves as a lubricant, suppressing destruction of the coating layer of the composite magnetic material.

Further, the method of manufacturing a soft magnetic material preferably includes, after the step of compression molding the mixed powder, the step of subjecting the soft magnetic material to stabilizing heat treatment at a temperature of not less than 250° C. and not more than the thermal decomposition temperature of the non-thermoplastic resin. Furthermore, the method of manufacturing a soft magnetic material preferably includes, after the step of compression molding the mixed powder, the step of subjecting the soft magnetic material to stabilizing heat treatment at a temperature of not less than a glass transition temperature of the non-thermoplastic resin and not more than the thermal decomposition temperature of the non-thermoplastic resin.

Stabilizing heat treatment is a heat treatment for allowing the organic substance entering between the composite magnetic particles to be deformed to a shape fit into such a space for infiltration. A glass transition temperature is a temperature at which an amorphous high-molecular substance transits from a glass-like solid to a rubber-like state with an increase in temperature.

Stabilizing heat treatment at a temperature of not less than 200° C. and not more than a thermal decomposition temperature of the non-thermoplastic resin can suppress thermal decomposition of the organic substance, and stabilize the non-thermoplastic resin entering a gap between the composite magnetic materials. Thereby, a change over time is less likely to occur.

Further, the step of subjecting the soft magnetic material to stabilizing heat treatment preferably includes the step of subjecting the soft magnetic material to stabilizing heat treatment in an atmosphere of one of an inert gas and a reduced gas. Furthermore, the step of compression molding the mixed powder preferably includes the step of compression molding the mixed powder in an atmosphere of one of an inert gas and a reduced gas.

It is economically advantageous to perform compression molding and stabilizing heat treatment in an air atmosphere. When these steps are performed in an atmosphere of an inert gas and a reduced gas, however, they can suppress oxidization of the soft magnetic material by oxygen in the air, and they can also suppress reduction of the strength of the non-thermoplastic resin. For the reasons described above, it is preferable to perform compression molding and stabilizing heat treatment in an atmosphere of an inert gas or a reduced gas.

The organic substance contained in the soft magnetic material has a grain size of not less than 0.1 μm and not more than 100 μm. When the organic substance has a grain size similar to or above a grain size of the composite magnetic particle, the organic substance is unevenly distributed in the soft magnetic material, causing unevenness in density. This results in unevenness in mechanical strength and electrical property in the soft magnetic material. Further, by setting the grain size of the organic substance at not less than 0.1 μm, the steps of mixing the organic substance and the composite magnetic particle and compression molding the mixed powder can easily be performed in a technical sense.

As described above, according to the present invention, a soft magnetic material having high magnetic property and mechanical strength and also having fatigue property and resistivity satisfying durability enough for use as a motor core or the like, and a method for manufacturing the same can be provided. Furthermore, a motor core and a transformer core made of the soft magnetic material can be provided.

### BRIEF DESCRIPTION OF THE DRAWINGS

FIG. 1 is a schematic view showing a section of a soft magnetic material in an embodiment of the present invention.

FIG. 2 is a sectional view showing a linear motor in the embodiment of the present invention.

FIG. 3 is a plan view showing a transformer core in the embodiment of the present invention.

### BEST MODES FOR CARRYING OUT THE INVENTION

A soft magnetic material in the present invention is obtained by mixing an organic substance and a composite magnetic particle having an insulative coating layer containing an oxide, and compression molding the mixed powder. Preferably, the soft magnetic material in the present invention is obtained by subjecting a compressed compact obtained by the compression molding to stabilizing heat treatment. An embodiment of the soft magnetic material in the present invention and a method for manufacturing the same will be described in the following.

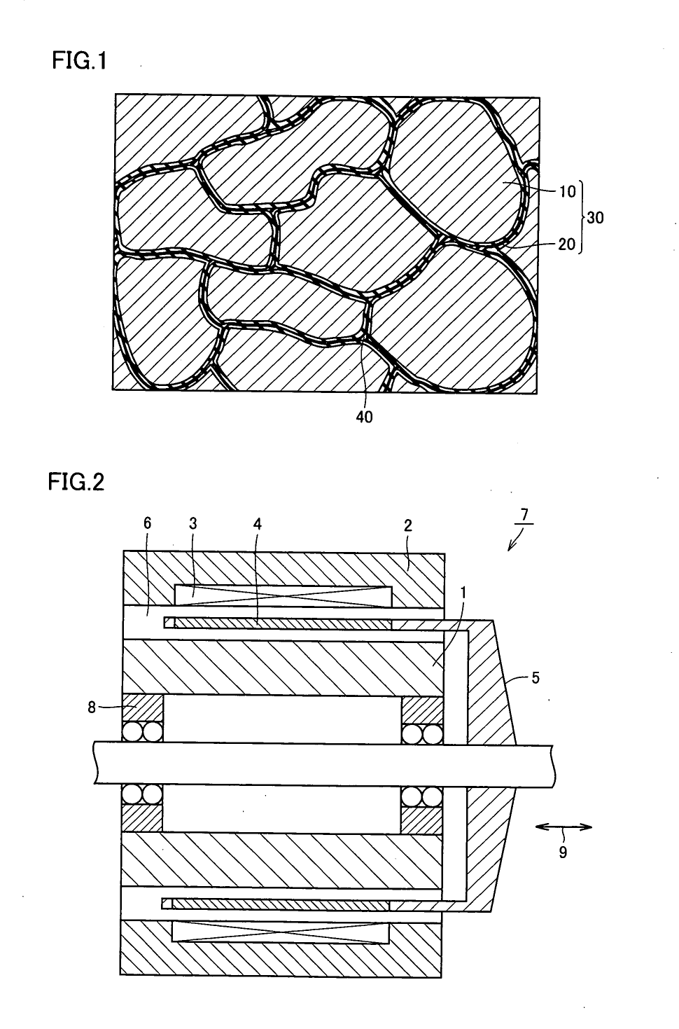

FIG. 1 is a schematic view showing a section of a soft magnetic material in an embodiment of the present invention. With reference to FIG. 1, the soft magnetic material includes a composite magnetic particle 30 having a metallic magnetic particle 10 and an insulative coating layer 20 as a coating layer coating metallic magnetic particle 10 and containing an oxide, and an organic substance 40. Organic substance 40 is formed by adding at least one of a thermoplastic resign and a higher fatty acid to a non-thermoplastic resin. Organic substance 40 is contained in the soft magnetic material by not less than 0.001% by mass and not more than 0.2% by mass.

To manufacture the soft magnetic material shown in FIG. 1, firstly, the organic substance is mixed with the composite magnetic material, in which the metallic magnetic particle is coated with the insulative coating layer containing the oxide, to obtain mixed powder. On this occasion, the mixing ratio in the mixed powder is adjusted such that the organic substance occupies not less than 0.001% by mass and not more than 0.2% by mass in the soft magnetic material. There is no specific limitation on the mixing technique, and any mixing technique such as ball milling, mechanical alloying, or mechanofusion may be used.

As the metallic magnetic particle for the composite magnetic particle, a particle having high saturation magnetic flux density and magnetic permeability can be used, such as iron (Fe), an iron (Fe)-silicon (Si) alloy, an iron (Fe)-nitrogen (N) alloy, an iron (Fe)-nickel (Ni) alloy, an iron (Fe)-carbon (C) alloy, an iron (Fe)-boron (B) alloy, an iron (Fe)-cobalt (Co) alloy, an iron (Fe)-phosphorus (P) alloy, an iron (Fe)-aluminum (Al) alloy, or an iron (Fe)-nickel (Ni)-cobalt (Co) alloy.

The average grain size of the metallic magnetic particle is not less than 5 μm and not more than 400 μm. More preferably, the average grain size of the metallic magnetic particle is not less than 5 μm and not more than 200 μm. Setting the average grain size of the metallic magnetic particle at not less than 5 μm produces an effect that the particle is less oxidized and its magnetic property is less deteriorated than that having a smaller average grain size. Further, setting the average grain size of the metallic magnetic particle at not more than 400 μm can increase the density of the compressed compact without reducing compressibility at compression molding. It is to be noted that, to obtain the average grain size of the metallic magnetic particle, grain sizes of metallic magnetic particles are measured by sieving, and masses of the metallic magnetic particles are added in increasing order of grain size to reach 50% of the total mass of the measured metallic magnetic particles. The grain size obtained at that point (50% grain size D) is determined as the average grain size.

The insulative coating layer containing an oxide serves as an insulative layer and suppresses eddy current loss. Examples of the oxide for use include iron phosphate, which is a metallic oxide coating containing phosphorus and iron, and an oxide insulator such as manganese phosphate, zinc phosphate, calcium phosphate, aluminum phosphate, silicon oxide, titanium oxide, aluminum oxide, or zirconia oxide.

As the organic substance, any of a mixture of a non-thermoplastic resin and a thermoplastic resin, a mixture of a non-thermoplastic resin and a higher fatty acid, and a mixture of a non-thermoplastic resin, a thermoplastic resin and a higher fatty acid is used.

When the organic substance is a mixture of a non-thermoplastic resin, a thermoplastic resin and a higher fatty acid, it is preferable that, to the non-thermoplastic resin contained by not less than 0.001% by mass relative to the soft magnetic material, the thermoplastic resin is added by not less than 0.025% by mass relative to the soft magnetic material or the higher fatty acid is added by not less than 0.005% by mass relative to the soft magnetic material, and thereafter the content of the organic substance is set at not more than 0.2% by mass. With the addition of not less than 0.025% by mass of the thermoplastic resin or 0.005% by mass of the higher fatty acid, a soft magnetic material having an excellent fatigue property with a resistivity of not less than 1000 (μΩcm) can be obtained. Further, the content of the thermoplastic resin is preferably set at not less than 0.05% by mass relative to the soft magnetic material. With this setting, a soft magnetic material having an excellent fatigue property with a resistivity of not less than 3000 (μΩcm) can be obtained.

Examples of the non-thermoplastic resin include a wholly aromatic polyester and a wholly aromatic polyimide. Examples of the thermoplastic resin include a fluorine-type resin, a thermoplastic polyimide, a thermoplastic polyamide, a thermoplastic polyamideimide, and a high-molecular-weight polyethylene. A high-molecular-weight polyethylene is a polyethylene having a molecular weight of not less than 100,000. Further, examples of the higher fatty acid include zinc stearate, lithium stearate, calcium stearate, lithium palmitate, calcium palmitate, lithium oleate, and calcium oleate.

Preferably, the organic substance has a grain size of not less than 0.1 μm and not more than 100 μm. More preferably, the organic substance has a grain size of not less than 0.1 μm and not more than 60 μm. Thereby, further uniform mechanical strength and electrical property can be achieved.

Preferably, the grain size of the organic substance is not more than one tenth of the grain size of the composite magnetic particle. For example, when the average grain size of the composite magnetic particle is not more than 200 μm, the grain size of the organic substance is set at not more than 20 μm, and when the average grain size of the composite magnetic particle is not more than 150 μm, the grain size of the organic substance is set at not more than 15 μm. By using the organic substance having a grain size within such a value range, a particle of the organic substance can easily enter a gap between the composite magnetic particles, allowing the organic substance to be dispersed into the soft magnetic material more uniformly. This can further suppress unevenness in mechanical strength and insulation caused due to uneven distribution of the organic substance.

The mixed powder of the composite magnetic particle and the organic substance is put into a mold to be subjected to compression molding under a pressure between 390 (MPa) and 1500 (MPa). Thus, the soft magnetic material in which the mixed powder is compression molded is obtained. The organic substance serves as a lubricant between the composite magnetic particles.

Although compression molding may be performed in an air atmosphere, it is preferably performed in an atmosphere of an inert gas or a reduced gas. Though it is advantageous in terms of manufacturing cost to use nitrogen gas as an inert gas, argon gas or helium gas may be used.

The soft magnetic material obtained by compression molding is subjected to stabilizing heat treatment at a temperature of not less than 200° C. and not more than a thermal decomposition temperature of the non-thermoplastic resin. Thereby, the organic substance is thinly and uniformly stabilized between the composite magnetic particles. Although stabilizing heat treatment may be performed in an air atmosphere, it is preferably performed in an atmosphere of an inert gas or a reduced gas. Though it is advantageous in terms of manufacturing cost to use nitrogen gas as an inert gas, argon gas or helium gas may be used.

FIG. 2 is a sectional view showing a linear motor in the embodiment of the present invention. With reference to FIG. 2, in a linear motor 7, the soft magnetic material in accordance with the present invention is compression molded and used as an iron core for a motor.

Linear motor 7 includes an inner core 1, an outer core 2 with a gap 6 perpendicular to an axis direction (a direction indicated by an arrow 9) formed between inner core 1 and outer core 2, a coil 3 provided within outer core 2, and a magnet 4 positioned within gap 6, and has a movable body 5 integrated with magnet 4 and movable in the axis direction. Movable body 5 is supported by a bearing 8.

One or both of inner core 1 and outer core 2 which are conventionally formed of a layered body of sheet iron are replaced with those formed by compression molding the soft magnetic material in accordance with the present invention within a mold. This can significantly simplify the assembling process of linear motor 7.

In this structure, when linear motor 7 is in operation, a magnetic flux passes through the inside of inner core 1 and outer core 2, and an eddy current is generated around a magnetic field line on this occasion. When the core has a low electrical resistance in a direction in which the magnetic field line passes through, the eddy current is increased and the increased amount is consumed as invalid energy in motor input. This results in a reduction in motor efficiency. Consequently, it is desirable for inner core 1 and outer core 2 to easily allow passage of the magnetic flux and to have a high electrical resistance. These desirable properties can be satisfied with inner core 1 and outer core 2 formed of the soft magnetic material in accordance with the present invention, implementing linear motor 7 which is highly efficient and easily assembled.

It is to be noted that, although explanation has been given on a linear motor, the soft magnetic material in accordance with the present invention can also be applied to an iron core for a typical rotating motor or a transformer, implementing a core which has only a small energy loss due to an eddy current and is easy to manufacture.

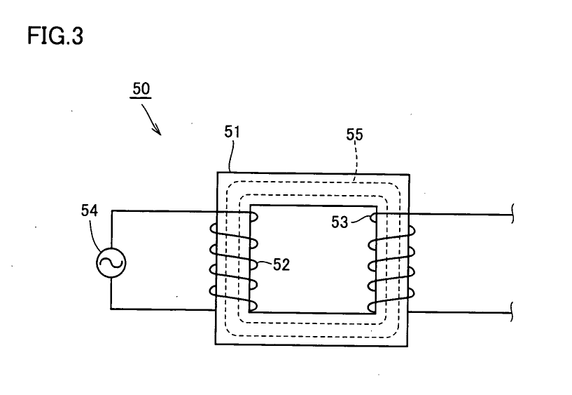

With reference to FIG. 3, a transformer 50 includes a circularly extending transformer core 51 formed by compression molding the soft magnetic material in accordance with the present invention. Two coils, a primary coil 52 and a secondary coil 53, are wound onto transformer core 51. Primary coil 52 is connected to an alternating current power supply 54 and secondary coil 53 is connected to a load not shown. When a current flows through primary coil 52, a magnetic flux 55 is generated within transformer core 51, and the generation of magnetic flux 55 induces a voltage across secondary coil 53. The value of the voltage can be changed by varying the value of the current flown through primary coil 52, the turn ratio between primary coil 52 and secondary coil 53, or the like.

The soft magnetic material in accordance with the present invention was evaluated in an example which will be described hereinafter.

“Somaloy 500” manufactured by Hoganas was used as the composite magnetic particle. In the particle, a phosphate compound coating as the coating layer is formed on the surface of an iron particle as the metallic magnetic particle. The average grain size of the iron particle is not less than 150 μm, and the average thickness of the phosphate compound coating is 20 nm.

“UIP-R” manufactured by Ube Industries, Ltd. was used as the non-thermoplastic resin for the organic substance. Chemically, UIP-R is a wholly aromatic polyimide using biphenyl tetracarboxylic dianhydride, and its average grain size is 10 μm. The glass transition temperature and the thermal decomposition temperature of UIP-R are 285° C. and 548° C., respectively.

“LB1” manufactured by Hoganas was used as the thermoplastic resin for the organic substance. LB1 is a thermoplastic polyamide having the melting temperature of 220° C.

Zinc stearate was used as the higher fatty acid for the organic substance. The melting temperature of zinc stearate is 135° C.

The composite magnetic particle and materials for the organic substance described above were mixed in a ball mill to obtain mixed powder. The ball mill was rotated at 36 rpm and the mixing was carried out for two hours. Plural types of the mixed powder having different contents of the materials for the organic substance were prepared by varying mixed amounts of UIP-R, LB1 and zinc stearate, which are the organic materials.

Each type of the mixed powder was put into a mold for compression molding to form a soft magnetic material. The compression molding was performed in an atmosphere of nitrogen gas. The temperature condition was set at normal temperature, and the compression pressure was set at 900 (MPa).

The obtained soft magnetic material was subjected to stabilizing heat treatment. The stabilizing heat treatment was performed for 30 minutes at 300° C. in an atmosphere of nitrogen gas.

Through the process described above, sample soft magnetic materials numbered 1 to 19 were formed. Table 1 lists the contents of UIP-R, LB1 and zinc stearate contained in the sample soft magnetic materials numbered 1 to 19. To distinguish whether or not a sample is the soft magnetic material according to the present invention, sample types are listed to indicate whether the sample belongs to the example or a comparative example.

It is to be noted that the contents of the organic materials listed in Table 1 are values obtained by measuring the soft magnetic materials which have been subjected to stabilizing heat treatment by gas chromatography-mass spectroscopy, and they substantially match the contents of the mixed organic materials in the heating condition of the present example.

TABLE 1

| | Content of | | Content of Zinc | |
|---|---|---|---|---|
| Sample | UIP-R | Content of LB1 | Stearate | Sample |
| No. | (% by mass) | (% by mass) | (% by mass) | Type |
| 1 | 0.05 | 0.025 | 0 | Example |
| 2 | 0.05 | 0.05 | 0 | Example |
| 3 | 0.05 | 0.075 | 0 | Example |
| 4 | 0.05 | 0.1 | 0 | Example |
| 5 | 0.05 | 0.125 | 0 | Example |
| 6 | 0.05 | 0.15 | 0 | Example |
| 7 | 0.05 | 0.175 | 0 | Comparative |
| | | | | example |
| 8 | 0.1 | 0.05 | 0 | Example |
| 9 | 0.10 | 0.10 | 0 | Example |
| 10 | 0.10 | 0.15 | 0 | Comparative |
| | | | | example |
| 11 | 0.1 | 0 | 0.005 | Example |
| 12 | 0.05 | 0 | 0.005 | Example |
| 13 | 0.05 | 0.05 | 0.005 | Example |
| 14 | 0.001 | 0.025 | 0 | Example |
| 15 | 0.001 | 0 | 0.005 | Example |
| 16 | 0.001 | 0.025 | 0.005 | Example |
| 17 | 0 | 0.1 | 0 | Comparative |
| | | | | example |
| 18 | 0 | 0.15 | 0 | Comparative |
| | | | | example |
| 19 | 0 | 0.6 | 0 | Comparative |
| | | | | example |

Next, the sample soft magnetic materials numbered 1 to 19 listed in Table 1 were used to make a test piece for a three-point-bending transverse rupture strength test having a size of 10 mm by 10 mm by 55 mm, and a test piece for a repeated three-point-bending transverse rupture strength test having a size of 3 mm by 4 mm by 40 mm. The test piece for the three-point-bending transverse rupture strength test was used to conduct the three-point-bending transverse rupture strength test. The three-point-bending transverse rupture strength test was conducted under normal temperature, with the test piece supported with a span of 40 mm. Further, the test piece for the repeated three-point-bending transverse rupture strength test was used to conduct a 10⁷ times-repeated three-point-bending transverse rupture strength test and a 10⁸ times-repeated three-point-bending transverse rupture strength test. The repeated three-point-bending transverse rupture strength tests were conducted under normal temperature, with the test piece supported with a span of 30 mm. Furthermore, densities of the sample soft magnetic materials numbered 1 to 19 were measured.

Table 2 lists the densities of the soft magnetic materials and transverse rupture strengths obtained through the three-point-bending transverse rupture strength test, the 10⁷ times-repeated three-point-bending transverse rupture strength test, and the 10⁸ times-repeated three-point-bending transverse rupture strength test, in conjunction with sample types.

TABLE 2

| | | | Transverse | Transverse | |
|---|---|---|---|---|---|
| | | Transverse | rupture | rupture | |
| | | rupture | strength ob- | strength ob- | |
| | | strength | tained by | tained by | |
| | | obtained | 10⁷ times- | 10⁸ times- | |
| | | by three- | repeated | repeated | |
| | | point- | three-point- | three-point- | |
| | | bending | bending | bending | |
| | | transverse | transverse | transverse | |
| | | rupture | rupture | rupture | |
| Sample | Density | strength | strength | strength | Sample |
| No. | (g/cm³) | test (MPa) | test (MPa) | test (MPa) | type |
| 1 | 7.56 | 153 | 102 | 102 | Example |
| 2 | 7.54 | 131 | 93 | 93 | Example |
| 3 | 7.53 | 130 | 93 | 93 | Example |
| 4 | 7.51 | 126 | 83 | 83 | Example |
| 5 | 7.49 | 120 | 81 | 81 | Example |
| 6 | 7.48 | 123 | 82 | 82 | Example |
| 7 | 7.47 | 117 | 74 | 74 | Com. |
| | | | | | example |
| 8 | 7.51 | 128 | 85 | 85 | Example |
| 9 | 7.49 | 120 | 80 | 80 | Example |
| 10 | 7.45 | 113 | 71 | 71 | Com. |
| | | | | | example |
| 11 | 7.54 | 138 | 97 | 97 | Example |
| 12 | 7.55 | 145 | 100 | 100 | Example |
| 13 | 7.53 | 133 | 94 | 94 | Example |
| 14 | 7.57 | 138 | 99 | 99 | Example |
| 15 | 7.57 | 130 | 92 | 92 | Example |
| 16 | 7.55 | 125 | 84 | 84 | Example |
| 17 | 7.57 | 124 | 82 | 82 | Com. |
| | | | | | example |
| 18 | 7.50 | 80 | 52 | 52 | Com. |
| | | | | | example |
| 19 | 7.19 | 30 | 18 | 18 | Com. |
| | | | | | example |

As can be seen in Table 2, it was confirmed that a high transverse rupture strength is obtained in the repeated three-point-bending transverse rupture strength test when the non-thermoplastic resin is added in the organic substance and the content of the organic substance is not less than 0.001% by mass and not more than 0.2% by mass. It was also confirmed that a low transverse rupture strength is obtained in the three-point-bending transverse rupture strength test when the non-thermoplastic resin is contained but the content of the organic substance is too high.

Next, the sample soft magnetic materials numbered 1 to 19 listed in Table 1 were used to make a ring-shaped test piece for measuring a magnetic flux density having an internal diameter of 25 mm, an external diameter of 35 mm and a thickness of 5 mm, and a test piece for measuring a resistivity having a size of 3 mm by 1 mm by 40 mm. The test piece for measuring the magnetic flux density was used to determine a flux density B100 when a magnetic field of 100 (oersted) (=8.0×10³ (A/m)) was applied to the test piece at normal temperature. For the coils applying the magnetic field to the test piece, the numbers of turns of the primary coil and the secondary coil were set at 300 times and 20 times, respectively, and the output from the secondary coil was measured. Further, the test piece for measuring the resistivity was used to measure the resistivity by four-terminal method.

Table 3 lists the values of magnetic densities B100 and resistivities obtained by the above measurement, in conjunction with sample types.

TABLE 3

| Sample | Magnetic flux | Resistivity | Sample |
|---|---|---|---|
| No. | B100 (T) | (μΩcm) | type |
| 1 | 1.56 | 1830 | Example |
| 2 | 1.51 | 3300 | Example |
| 3 | 1.49 | 4470 | Example |
| 4 | 1.46 | 5600 | Example |
| 5 | 1.42 | 6000 | Example |
| 6 | 1.42 | 6800 | Example |
| 7 | 1.39 | 7300 | Comparative |
| | | | example |
| 8 | 1.47 | 6700 | Example |
| 9 | 1.41 | >10000 | Example |
| 10 | 1.38 | >10000 | Comparative |
| | | | example |
| 11 | 1.50 | 1860 | Example |
| 12 | 1.51 | 1050 | Example |
| 13 | 1.50 | 3700 | Example |
| 14 | 1.57 | 1790 | Example |
| 15 | 1.52 | 1010 | Example |
| 16 | 1.50 | 1870 | Example |
| 17 | 1.55 | 520 | Comparative |
| | | | example |
| 18 | 1.55 | 5000 | Comparative |
| | | | example |
| 19 | 1.10 | >10000 | Comparative |
| | | | example |

As can be seen from Tables 2 and 3, it was confirmed that a soft magnetic material having high durability resistant to repeated transverse rupture strength as well as high magnetic flux density and resistivity can be obtained by adding at least one of the thermoplastic resin and the higher fatty acid to the non-thermoplastic resin and setting the content of the organic substance at not less than 0.001% by mass and not more than 0.2% by mass.

It should be understood that the embodiment and the example disclosed herein are by way of illustration in all respects and not by way of limitation. The scope of the present invention is defined not by the above description but by the appended claims, and is intended to include all the modifications within the meaning and the scope equivalent to those of the claims.

### INDUSTRIAL APPLICABILITY

The present invention is mainly utilized for electric and electronic components such as a motor core, a transformer core or the like formed of a compressed powder compact of a soft magnetic material.

1. A soft magnetic material comprising a composite magnetic particle and an organic substance, said composite magnetic particle having a metallic magnetic particle and a coating layer coating said metallic magnetic particle and containing an oxide therein,
wherein said organic substance is formed by adding at least one of a thermoplastic resin and a higher fatty acid to a non-thermoplastic resin, and
said organic substance is contained in said soft magnetic material by not less than 0.001% by mass and not more than 0.2% by mass, and said non-thermoplastic resin is contained in said soft magnetic material by not more than 0.1% by mass.

2. The soft magnetic material according to claim 1, wherein said thermoplastic resin is one of a fluorine-type resin, a thermoplastic polyimide, a thermoplastic polyamide, and a thermoplastic polyamideimide.

3. The soft magnetic material according to claim 1, wherein said higher fatty acid is zinc stearate.

4. The soft magnetic material according to claim 1, wherein a magnetic flux density is not less than 1.4 (tesla) and a resistivity is not less than 1000 (μΩcm) when a magnetic field of 8.0×10³ (A/m) is applied.

5. The soft magnetic material according to claim 1, wherein said non-thermoplastic resin is a wholly aromatic polyimide using biphenyl tetracarboxylic dianhydride.

6. A motor core using an iron core made of the soft magnetic material according to claim 1.

7. A transformer core using an iron core made of the soft magnetic material according to claim 1.

8. A method of manufacturing a soft magnetic material comprising a composite magnetic particle and an organic substance, said composite magnetic particle having a metallic magnetic particle and a coating layer coating said metallic magnetic particle and containing an oxide therein, the method comprising the steps of:
mixing said organic substance and said composite magnetic particle such that said organic substance formed by adding at least one of a thermoplastic resin and a higher fatty acid to a non-thermoplastic resin is contained in said soft magnetic material by not less than 0.001% by mass and not more than 0.2% by mass and said non-thermoplastic resin is contained in said soft magnetic material by not more than 0.1% by mass,
compression molding mixed powder obtained by the step of mixing, and
after the step of compression molding said mixed powder, subjecting said soft magnetic material to stabilizing heat treatment at a temperature of not less than 200° C. and not more than a thermal decomposition temperature of said non-thermoplastic resin.

9. The method of manufacturing a soft magnetic material according to claim 8, wherein the step of subjecting said soft magnetic material to stabilizing heat treatment includes the step of subjecting said soft magnetic material to stabilizing heat treatment in an atmosphere of one of an inert gas and a reduced gas.

10. The method of manufacturing a soft magnetic material according to claim 8, wherein said organic substance contained in the soft magnetic material has a grain size of not less than 0.1 μm and not more than 100 μm.

11. The method of manufacturing a soft magnetic material according to claim 8, wherein the step of compression molding said mixed powder includes the step of compression molding said mixed powder in an atmosphere of one of an inert gas and a reduced gas.
